(19) United States
(12) Patent Application Publication
(10) Pub. No.: US 2012/0065416 A1
(43) Pub. Date: Mar. 15, 2012

(54) Methods for Production of Biodiesel

(75) Inventors: Lance Seefeldt, Providence, UT (US); Bradley Wahlen, Hyrum, UT (US); Robert Willis, Logan, UT (US); Alexander McCurdy, Logan, UT (US)

(73) Assignee: Utah State University, North Logan, UT (US)

(21) Appl. No.: 13/233,676

(22) Filed: Sep. 15, 2011

Related U.S. Application Data
(60) Provisional application No. 61/383,253, filed on Sep. 15, 2010.
(60) Provisional application No. 61/415,681, filed on Nov. 19, 2010.

(51) Int. Cl. C07F 9/10; C11C 3/00; C11C 3/04

(52) U.S. Cl. 554/78; 554/170; 554/167; 554/227

(57) ABSTRACT

The present invention relates to methods useful for converting microbial lipids from an oleaginous microbial biomass into fatty acid alcohol esters, without prior extraction of the lipids from the biomass. The present invention also relates to fatty acid alcohol esters produced by the methods described herein. The fatty acid alcohol esters produced by the methods described herein may be useful as biodiesel, or a component thereof. In embodiments, the converting of microbial lipids to fatty acid alcohol esters may be accomplished by contacting an acid catalyst, an alcohol and an oleaginous microbial biomass containing microbial lipids under sufficient conditions and for a sufficient period of time for in situ transesterification reaction of at least some microbial lipids to their corresponding fatty acid alcohol ester.

### CROSS REFERENCE TO RELATED APPLICATIONS

This non-provisional application filed under 37 CFR 1.53(b) claims priority under U.S.C. section 119(e) to U.S. patent application No. 61/383,253, entitled “Biodiesel Production by Simultaneous Extraction and Conversion of Total Lipids,” filed on Sep. 15, 2010, the entire contents of which are incorporated herein by reference. This application also claims priority under U.S.C. section 119(e) to U.S. patent application No. 61/415,681, entitled “Biodiesel Production by Simultaneous Extraction and Conversion of Total Lipids from Microalgae, Cyanobacteria and Mixed Wild Cultures” filed on Nov. 19, 2010, the entire contents of which are incorporated herein by reference.

### BACKGROUND OF THE INVENTION

Biodiesel is a renewable fuel that can be produced from biological oils derived from plants, animals, or microbes. The oils (triglycerides) are converted by transesterification using alcohols (e.g., methanol) and catalyst (base or acid) to yield glycerol and the fatty acid alkyl ester or fatty acid methyl ester (FAME) if methanol is the alcohol. For a number of reasons, there is interest in developing different feedstocks to provide triglycerides as a source for biodiesel production other than traditional oilseed crops (i.e. soybean and canola). Microalgae offer many potential advantages as a non-food feedstock for biodiesel production, although this potential has yet to be realized because of several remaining technical barriers. For example, life cycle analysis conducted on the process of biodiesel production from microalgae indicates that 90% of the process energy is consumed by oil extraction, indicating that any improvement in lipid extraction will have a significant impact on the economics of the process. Many microalgae are known that accumulate significant quantities of triglycerides (20-50% of total dry weight). One approach to converting algal triglycerides to biodiesel requires that the lipids are first extracted using organic solvents (e.g., hexanes, chloroform, and methanol). The solvents are removed by distillation and the triglycerides are then reacted with acid or base and an alcohol (e.g. methanol) to make the FAME.

### SUMMARY OF THE INVENTION

The present invention relates to methods useful for converting microbial lipids from an oleaginous microbial biomass into fatty acid alcohol esters, without prior extraction of the lipids from the biomass. The present invention also relates to fatty acid alcohol esters produced by the methods described herein. The fatty acid alcohol esters produced by the methods described herein may be useful as biodiesel, or a component thereof. In embodiments, the converting of microbial lipids to fatty acid alcohol esters may be accomplished by contacting an acid catalyst, an alcohol and an oleaginous microbial biomass containing microbial lipids under sufficient conditions and for a sufficient period of time for in situ transesterification reaction of at least some microbial lipids to their corresponding fatty acid alcohol ester.

### BRIEF DESCRIPTION OF THE FIGURES

FIG. 1 shows the effect of methanol concentration on the extraction and conversion of algal lipids to biodiesel.

FIG. 2 shows temperature dependence of the extraction and conversion of algal lipids to methyl esters.

FIG. 3 shows methyl ester formation from N. oleoabundans cells.

FIG. 4 shows an example of the effect of water content on fatty acid ester production.

FIG. 5 shows the conversion of yeast triglycerides into a fatty acid alcohol ester.

FIG. 6 shows a GC trace of algal lipids prior to in situ transesterification.

FIG. 7 shows the progress of an in situ transesterification reaction of the algal lipids shown in FIG. 6.

FIG. 8 shows the completed in situ transesterification reaction of the algal lipids shown in FIG. 6.

### DETAILED DESCRIPTION OF THE INVENTION

“Biodiesel,” as used herein, shall mean a fuel comprising a fatty acid alcohol ester or mixture of fatty acid alcohol esters, wherein at least some of the fatty acid alcohol ester present in the fuel was produced from an oleaginous microbial biomass.

“Oleaginous,” as used herein, means lipid producing or lipid containing.

“TAG,” as used herein, means triglyceride.

The terms “oil” and “lipid” are used interchangeably herein.

The present invention relates to methods useful for converting microbial lipids from an oleaginous microbial biomass into fatty acid alcohol esters, without prior extraction of the lipids from the biomass. The fatty acid alcohol esters produced by the methods described herein are useful as biodiesel, or a component thereof. In embodiments, the converting of microbial lipids to fatty acid alcohol esters may be accomplished by contacting an acid catalyst, an alcohol and an oleaginous microbial biomass containing microbial lipids under sufficient conditions and for a sufficient period of time for in situ transesterification reaction of at least some microbial lipids to their corresponding fatty acid alcohol ester. Optionally, the contacting an acid catalyst, an alcohol, and an oleaginous microbial biomass containing microbial lipids may involve adding a volume of acid catalyst to a volume of alcohol to form an acid alcohol solution, then contacting the acid alcohol solution to the oleaginous microbial biomass. Examples of sufficient conditions and sufficient periods of time are disclosed herein. The examples presented are not meant to limit the scope of the invention. One skilled in the art would recognize minor changes to the conditions that would not affect the in situ transesterification process, and these modifications are within the inventive scope described herein. In embodiments, the present invention relates to methods for converting microbial lipids from an oleaginous microbial biomass into corresponding fatty acid methyl esters without prior extraction of the lipids from the microbial biomass. The microbial biomass may comprise yeast, algae, cyanobacteria, bacteria, or combinations thereof. This direct conversion of microbial lipids avoids the need to extract the microbial lipids from the microbial biomass prior to conversion. In embodiments, lipids that may be effectively converted include, but are not necessarily limited to phospholipids, glycolipids, free fatty acids, and glycerol bound fatty acids (mono-, di-, and triglycerides). AU of the lipids within a microbial source capable of undergoing in situ transesterification are herein collectively referred to as total lipids. In some embodiments, all microbial lipids capable of being converted into corresponding fatty acid alcohol esters, the total microbial lipids, are substantially converted.

In embodiments, the ratio of alcohol to microbial biomass may be equivalent to 1 titer of alcohol per kilogram of microbial biomass. Alternatively, the ratio of liters of alcohol to kilograms of microbial biomass may be approximately 2:1, 5:1, 10:1, 20:1 or 100:1. Alternatively, the ratio of liters of alcohol to kilograms of microbial biomass may be may be any ratio between 1:1 and 100:1.

In embodiments, a volume of acid catalyst may be added to the alcohol to create an alcohol and acid catalyst mixture, or reaction solution. The acid alcohol solution may then be contacted with a microbial biomass. The volume of acid to be added to the methanol may be between 0.5% and 5.0%, or between 1.0% and 3.0%, or between 1.2% and 2.4%, or approximately equal to 1.8% of the total volume (acid+alcohol). For example, a 100 ml reaction solution with 0.8% acid may comprise 1.8 ml of concentrated sulfuric acid.

The biomass and the acid alcohol (e.g. methanol) reaction solution may be mixed or brought into contact. The contacting of the acid alcohol solution with the biomass may occur in a vessel, or reactor, of sufficient size for carrying out the methods described herein. In some embodiments, the reaction solution and biomass occupy no more than half of the reactor. Optionally, the reactor may be equipped for stirring and a means to minimize solvent loss during the reaction heating. By way of example, the reactor may be fitted with a water-jacketed condenser. The biomass and acid alcohol solution is heated and refluxed for a period of time and at a temperature sufficient for transesterifying at least some of the microbial lipids. Optionally, at between 10% and 90%, or between 20% and 80%, or between 30% and 70%, or between 40% and 60%, or approximately 50% of the microbial lipids are transesterified. The temperature sufficient for esterification may be chosen with regard to the alcohol contained in the acid alcohol solution. For example, without limiting the invention, a temperature 60-65° C. may be used for methanol. Any temperature sufficient for transesterification, which also falls below the boiling temperature for a particular alcohol, may be used. The time the biomass and acidic alcohol are heated and refluxed may be sufficient for transesterifying at least some of the microbial lipids. Optionally, at between 10% and 90%, or between 20% and 80%, or between 30% and 70%, or between 40% and 60%, or approximately 50% of the microbial lipids are transesterified. For example, the time may be between 1 hour and 5 hours, or up to 10 hours, or up to 24 hours, or up to 72 hours.

Once the reaction is substantially complete and the solution has reached a temperature sale for handling, the residual biomass may be removed. Optionally, the residual biomass is removed by filtration. The remaining solution may be neutralized. For example, neutralization of the remaining solution may be achieved using a base. Optionally, the base is one that wilt not react with the fatty acid methyl ester. For example, the base may be sodium bicarbonate. Next, the alcohol may be removed. Optionally, the alcohol is removed by simple distillation. Simple distillation may allow for reuse of the alcohol. The reacted solution may contain at least some fatty acid alcohol esters. For example, the fatty acid alcohol ester may be a fatty acid methyl ester. The reacted solution may also contain a significant amount of chlorophyll. Optionally, the chlorophyll may be removed. Removal of the chlorophyll may improve the quality of the fatty acid alcohol ester fuel, or biodiesel. Optionally, chlorophyll may be removed by vacuum distillation. For example, to recover fatty acid methyl esters by vacuum distillation a temperature between 120° C. and 160° C., or between 145° C. and 155° C., or of approximately 150° C. may be used. Other fatty acid alcohol esters may also be recovered in this way. One skilled in the art would recognize temperature sufficient for recover of fatty acid alcohol esters produced by the methods described herein, and such recovery is within the scope and inventive nature of this disclosure. For example, Chlorophyll has a higher boiling point than fatty acid methyl esters; therefore, any temperature above the boiling point of fatty acid methyl esters and below the boiling point of chlorophyll may be sufficient for the recovery of fatty acid methyl esters by vacuum distillation. Optionally, at this point the fatty acid methyl ester biodiesel may be substantially pure and of fuel grade quality.

Alternatively, a step for extracting a fatty acid alcohol ester, pigment and chloroform mixture from a water and alcohol mixture, and a step for distilling the fatty acid ester, pigment and chloroform mixture to produce a crude fatty acid ester mixture, and a step for distilling the crude fatty acid ester to produce a substantially pure fatty acid alcohol ester, may be included.

In some embodiments, the present invention relates to methods for converting algal lipids from an algal biomass into corresponding fatty acid alcohol esters without prior extraction of the lipids from the algal biomass. For example, where the alcohol used is methanol, fatty acid methyl esters may be produced. According to methods related to the present invention, to accomplish the conversion of algal lipids to fatty acid alcohol esters, the algal lipids are transesterified. The transesterification may be carried out by contacting the algal lipids with an alcohol and an acid catalyst, under sufficient conditions to transesterify at least some of the algal lipids. First, the algal biomass may be heated in the presence of an alcohol and an acid. The alcohol may be chosen from methanol, ethanol, propanol, butanol, isobutanol, or another alcohol capable of reacting with the algal lipids under the conditions described herein. The acid may be, for example, sulfuric acid, or any non-gaseous acid catalyst capable of catalyzing the transesterification of algal lipids. Alternatively, an alcohol or acid, or both, may be added to a pre-heated algal biomass.

In embodiments, the ratio of alcohol to algal biomass may be equivalent to 1 liter of alcohol per kilogram of algal biomass. Alternatively, the ratio of titers of alcohol to kilograms of algal biomass may be approximately 2:1, 5:1, 10:1, 20:1 or 100:1. Alternatively, the ratio of liters of alcohol to kilograms of algal biomass may be may be any ratio between 1:1 and 100:1.

A volume of acid catalyst may be added to the alcohol to create an alcohol and acid catalyst mixture, or acid alcohol solution for reaction. Optionally, the volume of acid to be added to the alcohol may be between 0.5% and 5.0%, or between 1.0% and 3.0%, or between 1.2% and 2.4%, or approximately equal to 1.8% of the total volume (acid+methanol). For example, a 100 ml reaction solution with 1.8% acid may comprise 1.8 ml of concentrated sulfuric acid.

The biomass and the acid methanol reaction solution may be mixed or brought into contact to all allow for in situ transesterification reaction to occure. The contacting of the acid methanol solution with the biomass may occur in a vessel of sufficient size for carrying out the methods described herein. In some embodiments, the reaction solution and biomass occupy no more than half of the reactor. Optionally, the reactor may be equipped for stirring and a means to minimize solvent loss during the reaction heating. By way of example, the reactor may be fitted with a water-jacketed condenser. The biomass and acidic methanol solution is heated and refluxed for a period of time and at a temperature sufficient for transesterifying at least some of the algal lipids. Optionally, at between 10% and 90%, or between 20% and 80%, or between 30% and 70%, or between 40% and 60%, or approximately 50% of the algal lipids are transesterified. The temperature sufficient for esterification may be chosen with regard to the alcohol contained in the acid alcohol solution. For example, without limiting the invention, a temperature 60-65° C. may be used for methanol. Any temperature sufficient for transesterification, which also falls below the boiling temperature for the alcohol in use, may be used. The time the biomass and acidic alcohol are heated and refluxed may be sufficient for transesterifying at least some of the algal lipids. Optionally, at between 10% and 90%, or between 20% and 80%, or between 30% and 70%, or between 40% and 60%, or approximately 50% of the algal lipids are transesterified. For example, the time may be between 1 hour and 5 hours, or up to 10 hours, or up to 24 hours, or up to 72 hours.

Once the reaction is substantially complete and the solution has reached a temperature safe for handling, the residual biomass may be removed. Optionally, the residual biomass is removed by filtration. The remaining solution may be neutralized. For example, neutralization of the remaining solution may be achieved using a base. Optionally, the base is one that will not react with, for example, a fatty acid methyl ester. For example, the base may be sodium bicarbonate. Next, the alcohol (e.g. methanol) may be removed. Optionally, the alcohol is removed by simple distillation. Simple distillation may allow for reuse of the alcohol. The reacted solution may contain at least some fatty acid methyl esters. The reacted solution may also contain a significant amount of chlorophyll. Optionally, the chlorophyll may be removed. Removal of the chlorophyll may improve the quality of the fatty acid methyl ester fuel, or biodiesel. Optionally, chlorophyll may be removed by vacuum distillation. To recover fatty acid methyl esters by vacuum distillation a temperature between 120° C. and 160° C., or between 145° C. and 155° C., or of approximately 150° C. may be used. Chlorophyll has a higher boiling point than fatty acid methyl esters; therefore, any temperature above the boiling point of fatty acid methyl esters and below the boiling point of chlorophyll may be sufficient for the recovery of fatty acid methyl esters by vacuum distillation. At this point the fatty acid methyl ester biodiesel may be substantially pure and of fuel grade quality.

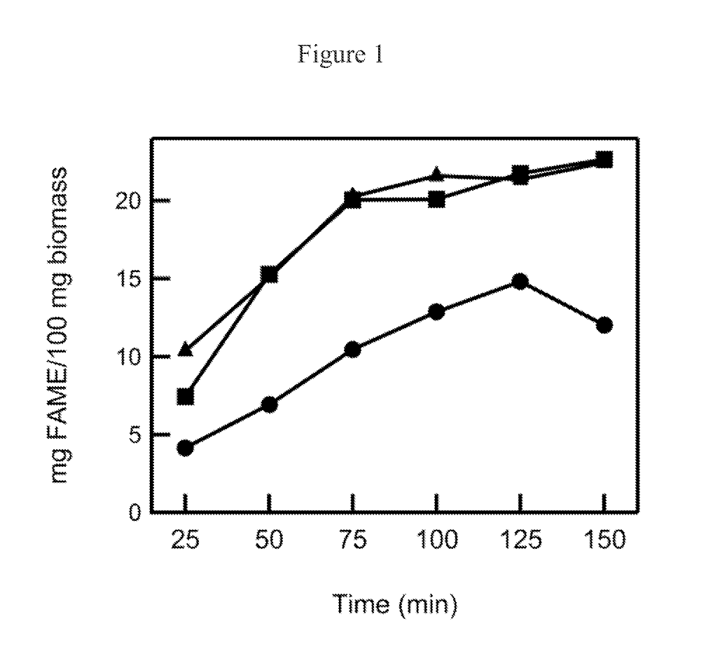

Referring now to FIG. 1, there is shown the effect of methanol concentration on the extraction and conversion of algal lipids to biodiesel. Reactions were performed by heating 100 mg of lyophilized C. gracilis cells to 60° C. with varying volumes of methanol containing 1.2% (v/v) H₂SO₄. The total yield of fatty acid methyl esters obtained per reaction with 100 mg biomass is plotted against the time of reaction. Volumes of methanol tested were , 1 mL; ▪, 2.5 mL; and ▴, 5 ml.

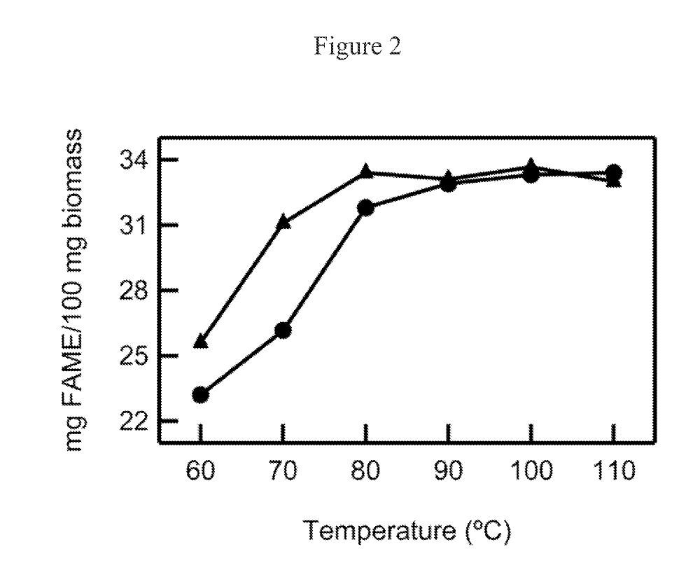

Referring now to FIG. 2, there is shown the temperature dependence of the extraction and conversion of algal lipids to methyl esters. All reactions were performed with 100 mg of lyophilized C. gracilis cells and 2 mL of methanol containing 2.0% (v/v) H₂SO₄. The total yield of fatty acid methyl esters obtained per reaction is plotted against the temperature of the reaction. Reactions were performed for , 10 min; and ▴, 20 min.

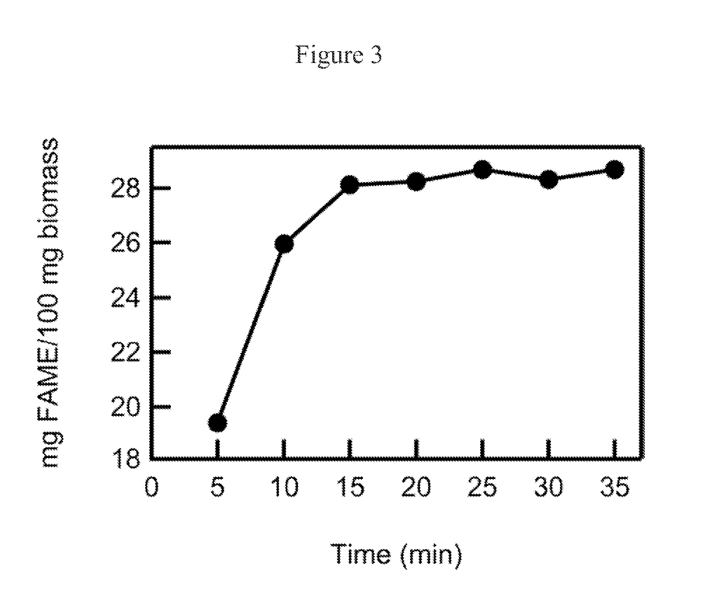

Referring now to FIG. 3, there is shown th extent of methyl ester formation from N. oleoabundans cells. The TAG content of the cells was 3.4% of the total dry weight. Reactions were performed with 100 mg of N. oleoabundans cells at 80° C. with 2 mL of methanol containing 2.0% (v/v) H₂SO₄. The total yield of methyl esters is plotted against the time of reaction.

### EXAMPLES

The following examples are illustrative of different embodiments of the present disclosure, and are not intended to limit the scope of the present disclosure.

### Example 1

### Strains and Culture Conditions

In embodiments, the present disclosure provides for the direct conversion of algal lipids to fatty acid esters using strains shown in Table 1. Any algal strain contain algal lipids may be used to practice the methods of the present disclosure.

TABLE 1
Strains used in this study.

| Strains | Media | Source |
|---|---|---|
| Chaetoceros gracilis | Artificial seawater | UTEX^{a} (LB 2658) |
| Phaeodactylum tricornutum | Artificial seawater | UTEX^{a} (640) |
| Tetraselmis suecica | Artificial seawater | UTEX^{a} (LB 2286) |
| Neochloris oleoabundans | Bristol media | UTEX^{a} (1185) |
| Chlorella sorokiniana | Bristol media | UTEX^{a} (1602) |
| Synechocystis sp. PCC 6803 | BG-11 | Hu et. al. 2000^{b} |
| Synechococcus elongatus | BG-11 | Hu et. al. 2000^{b} |

^{a}The Culture Collection of Algae at the University of Texas at Austin.
^{b}Hu, Q., Westerhoff, P., Vermaas, W., 2000. Removal of nitrate from groundwater by cyanobacteria: quantitative assessment of factors influencing nitrate uptake. Appl. Environ. Microbiol. 66, 133-139.

Stocks of each culture for strains shown in Table 1 were maintained in 250 mL of media in 500 mL baffled flasks, rotating at 140 rpm, and illuminated from overhead by Cool White fluorescent lighting (180 μmol photons m⁻¹ s⁻¹) on a 14:10 (light:dark) photoperiod. Unless otherwise stated, larger cultures were grown in 5 L Cell-Stir flasks (Wheaton industries. Inc., Millville, N.J.) illuminated by Cool White fluorescent lights (280 μmol photons m⁻² s⁻¹), with slow stirring (˜50 rpm) and aeration at the bottom of the vessel with air supplemented with 1% (v/v) CO₂. Artificial seawater media used to culture marine strains contained the following components per liter: NaCl (18 g), KCl (0.6 g), MgSO₄.7H₂O (1.3 g), CaCl₂.2H₂O (100 mg), K₂HPO₄ (250 mg), CaSiO₃ (25 mg), NaNO₃ (150 mg), and ferric ammonium citrate (5 mg). In addition, 1 mL of the following trace element solution was added per liter of media: H₃BO₃ (600 mg L⁻¹), MnCl₂.4H₂O (250 mg L⁻¹), ZnCl₂ (20 mg L⁻¹), CuCl₂.2H₂O (15 mg L⁻¹), Na₂MoO₄.2H₂O (15 mg L⁻¹), CoCl₂.6H₂O (15 mg L⁻¹), NiCl₂.6H₂O (10 mg L⁻¹), V₂O₅ (2 mg L⁻¹), and KBr (10 mg L⁻¹). Freshwater microalgal strains were grown using Bristol's medium modified to include ferric ammonium citrate (15 mg L⁻¹) (Bold, 1949), Cyanobacteria (Hu et al., 2000) were grown in BG-11 media containing the following composition per liter: NaNO₃ (1.5 g), MgSO₄.7H₂O (75 mg), CaCl₂.2H₂O (36 mg), citric acid (6 mg), H₃BO₃ (2.86 mg), MnCl₂.4H₂O (1.81 mg), ZnSO₄. 7H₂O (222 μg), Na₂MoO₄.2H₂O (390 μg), CuSO₄.5H₂O (79 μg), Co(NO₃)₂.6H₂O (49.4 μg), Ferric ammonium citrate (6 mg), Na₂CO₃ (20 mg), and KH₂PO₄ (30.5 mg). In addition to growth in 5 L culture flasks, C. gracilis was cultured in a 220 L raceway (Separation Engineering, Escondido, Calif.). The inoculum for the raceway was prepared by increasing the volume of a 5 L C. gracilis culture to 50 L in a polyethylene bag (#S2942, U-Line, Waukegan, Ill.). The bag culture was mixed vertically by air supplemented with 1% CO₂. The raceway was maintained at a pH of 7.5 by the introduction of CO₂ and mixed by a paddle wheel. The raceway and bag culture were positioned in a greenhouse where ambient solar light was supplemented with sodium vapor lamps. Once the C. gracilis raceway culture reached stationary growth phase, cells were harvested by centrifugation, frozen immediately, and lyophilized (Labconco, Kansas City, Mo.) prior to lipid analysis or experimental reactions. Wild cultured cells were obtained by centrifugation of water from the Logan city (Utah) wastewater lagoon.

### Example 2

### In Situ Transesterification

Without limited the invention, methods of the present disclosure may be used to carry out in situ transesterification. For example, experiments to determine the optimal conditions for biodiesel production were conducted with 100 mg of lyophilized algal biomass. Methanol containing sulfuric acid as a catalyst was added to the reaction vessel containing the algae and a PTFE coated stir bar (50 mm). Both the volume of methanol and the amount of sulfuric acid was varied to determine the amount necessary for optimal biodiesel production. Reactions were conducted in a commercial scientific microwave (CEM, Matthews, N.C.), where conditions of time and temperature could be controlled with precision. Once completed, reactions were stopped by the addition of chloroform to the reaction vessel forming a single-phase solution with the methanol. Phase separation was then accomplished by washing the methanol-chloroform solution with water (˜5 mL) followed by centrifugation. The methanol and sulfuric acid partitioned with the water in the upper phase, while FAME, TAG, and other lipids partitioned with chloroform in the lower, organic phase. The residual biomass formed a layer at the boundary between these two phases. The chloroform phase was removed with a gas tight syringe to a 10 mL volumetric flask. The remaining biomass was washed twice with 2 mL of chloroform to recover residual FAMEs and lipids. The total volume of chloroform was brought to 10 mL and mixed by inversion. Reaction conditions of time, temperature, catalyst concentration, and methanol volume were varied to determine optimal parameters for maximal biodiesel production from algal biomass by in situ transesterification.

### Example 3

### Total Lipid Analysis

In certain embodiments related to the present disclosure, a total lipid analysis may be conducted. For example, total lipids were extracted from dry algal biomass by using a chloroform:methanol (2:1) solvent mixture. Dried algae samples (200 mg) were sonicated (Sonifier 250, Branson, Danbury, Conn.) in 5 mL of chloroform:methanol (2:1) for approximately 30 s. The biomass was then collected at the bottom of the test tube by centrifugation and the solvent was removed to a weighed vial (EP scientific P/N 340-40C, Miami, Okla.). Extraction of biomass was repeated twice as described above. The organic extractions, pooled into a weighed vial, were dried by blowing a stream of argon gas for 12 h. The dried vials were weighed to establish the total lipid.

### Example 4

### Triglyceride Content Determination

In certain embodiments, the triglyceride (TAG) content of the algal biomass may be determined. For example, the TAG content of algal samples was determined by gas chromatography (GC) analysis of the total lipid extraction. Total lipid extraction was conducted on a 100 mg sample size. Each sample was placed in a 10 Mt microwave reaction tube along with a coated stir bar and 3 mL of chloroform:methanol (2:1) solution. Samples were maintained at 60° C. by microwave irradiation for 5 min. Once cooled, samples were centrifuged to collect the biomass at the bottom of the test tube to facilitate removal of the solvent, which was then removed to a 10 mL volumetric flask. Extraction was repeated twice and the final volume was adjusted to 10 mL with chloroform. The resulting solution was mixed by inversion and 1 mL was added to a GC vial for analysis.

### Example 5

### Lipid Quantification

In certain embodiments of the present disclosure, lipid quantification may be done. TAG and fatty acid methyl ester (FAME) content of algal samples was determined with a gas chromatograph (Model 2010, Shimadzu Scientific, Columbia, Md.) equipped with a programmable temperature vaporizer (PTV), split/splitless injector, flame ionization detector (FID), mass spectrometer (MS) (GCMS-QP2010S, Shimadzu Scientific, Columbia, Md.), and autosampler. Analytes were separated on an RTX-Biodiesel column (15 m, 0.32 mm ID, 0.10 μm film thickness, Restek, Bellefonte, Pa.) using a temperature program of 60° C. for 1 min followed by a temperature ramp of 10° C. per minute to 360° C. for 6 min. Constant velocity of helium as a carrier gas was set at 50 cm/sec in velocity mode. Sample sizes of 1 μL were injected into the PTV injector in direct mode that followed an identical temperature program to that of the column. The HD detector was set at 380° C. Each sample contained octacosane (10 μg/mL) as an internal standard. FID detector response to FAME and TAG was calibrated using methyl tetradecanoate (C14:0), methyl palmitoleate (C16:1), and methyl oleate (C18:1) at concentrations ranging from 0.1 mg/mL to 1 mg/mL and tripalmitin at concentrations ranging from 0.05 mg/mL to 0.5 mg/mL. Standards were obtained as pure compounds (Nu-Chek Prep, Inc., Elysian Minn.) and were diluted with chloroform to obtain the needed concentrations. A standard (GLC-68A, Nu-Chek Prep Inc.) containing methyl esters ranging from methyl tetradecanoate (C14:0) to methyl nervonate (C24:1) was used to identify the retention time window for FAME peak integration. Peaks within this region were integrated using GC solution postrun v. 2.3 (Shimadzu) and concentrations were determined by linear regression analysis. TAG concentration of samples was determined in a similar manner.

### Example 6

### GC/MS Analysis

In certain embodiments related to the disclosed invention, the fatty acid composition of the biodiesel obtained may be analyzed. For example, the fatty acid composition of the biodiesel obtained from algal strains was determined by GC/MS analysis, using the Shimadzu 2010 gas chromatograph described above. Samples were prepared by in situ transesterification as described above, using 2 nit methanol (2.0% H₂SO₄) and 100 mg biomass. Samples were heated to 80° C. for 20 min in the microwave. Samples were processed as described above for the in situ transesterification reactions. 1 μL of each sample was injected in the split-injection mode with a split ratio of 1:2. The split/splitless injector was connected to a stabilwax column (30 in, 0.25 mm ID, and 0.10 μm film thicknesses, Restek, Belafonte, Pa.) that interfaced with a mass spectrometer (GCMS-QP2010S, Shimadzu Scientific). The temperatures of the injector, interface and ion source were 235, 240, and 200° C., respectively. Helium was used as the carrier gas set at a constant velocity of 50 cm/s in velocity mode. Initially, the oven temperature was maintained at range scanned was 35 to 900 m/z at a rate of 2000 scan s⁻¹. Peak identification was accomplished by comparing mass spectra to the National Institute of Standards and Technology (NIST) 2005 mass spectral library (NIST, Gaithersburg, Md.).

### Example 7

### Optimization of Algal Biodiesel Production

In certain embodiments of the present disclosure, algal biodiesel production may be optimized. Optimization is optional. For example, a common method for establishing the biodiesel potential of an algal strain is to determine the total lipid content. This may be conventionally accomplished by extracting the biomass with a solvent mixture of both non-polar and polar solvents such as the mixture of chloroform and methanol in a 2:1 ratio. Because the resultant extract includes all lipid-soluble compounds from within the cell, it does not accurately represent how much biodiesel could be produced from a given sample. A method is disclosed herein to optimize the production of FAME from microalgae using a direct transesterification method covering a range of reaction parameters. Cells of the diatom C. gracilis were used as a representative feedstock for the development of this method due to their high TAG content (27% CDW). Reactions were performed utilizing a precision microwave instrument to allow for rapid screening of reaction conditions with a great degree of reproducibility. Each reaction was analyzed by gas chromatography using a method that allowed for the determination of FAME yield as well as quantification of residual TAG. Parameters for the successful conversion of algal lipids to biodiesel by direct transesterification were identified as the alcohol type used, the amount of alcohol per unit of biomass, temperature of reaction, and catalyst concentration.

### Example 8

### Alcohol Selection

In certain embodiments related to the present disclosure, a specific alcohol may be selected for the conversion of algal lipids to fatty acid esters. In the in situ transesterification process, alcohols perform a vital role, acting as both the solvent, extracting the lipids from the biomass and as the reactant, converting the lipids to fatty acid alkyl esters. Prior studies of in situ transesterification have investigated the efficiency of alcohols such as methanol, ethanol, 1-propanol, and n-butanol at extracting and converting biodiesel from soybean, rice bran, and sunflower seed. For example, to determine which alcohol would perform better in the production of biodiesel from the diatom C. gracilis, methanol, ethanol, 1-butanol, 2-methyl-1-propanol, and 3-methyl-1-butanol were used to determine the ability of each alcohol to both extract the oil and convert it to the corresponding fatty acid alkyl ester. Extracting C. gracilis cells with methanol removed significantly less TAG from the algal biomass than did the other four alcohols (Table 2).

TABLE 2
Effectiveness of different alcohols at
extracting and converting algal oil

| | | mg FAME per |
|---|---|---|
| Alcohol | mg TAG extracted^{a} | sample^{b} |
| methanol | 3.1 | 35.6 |
| ethanol | 20.2 | 30.8 |
| 1-butanol | 18.9 | 36.9 |
| 2-methyl-1-propanol | 19.5 | 28.7 |
| 3-methyl-1-butanol | 19.1 | 36.4 |

^{a}100 mg biomass extracted with 1 mL of alcohol heated to 60° C. by microwave irradiation for 10 min with constant stirring.
^{b}100 mg of biomass was heated to 60° C. for 100 min with 2 mL of alcohol and 1.8% (v/v) sulfuric acid.

Interestingly, when the same procedure was performed in the presence of 1.8% (v/v) H₂SO₄ as catalyst, the type of alcohol used did not have a significant effect on the amount of fatty acid alkyl esters obtained. Approximately equal amounts of fatty acid alkyl esters resulted from the in situ transesterification of algal biomass with each alcohol (Table 2). As a result, the lowest cost alcohol (methanol) was selected for optimization of the in situ transesterification reaction.

### Example 9

### The Effect of Methanol Volume

In certain embodiments related to the present disclosure, the alcohol volume may be varied or optimized. Previous studies of acid-catalyzed conversion of vegetable oil to FAME have shown that the extent of TAG conversion is influenced by the volume of methanol used per unit of oil. The volume of methanol used per unit of algal biomass may have a similar effect on the FAME yield from total algal lipids by in situ transesterification. For example, to identify the optimal methanol to biomass ratio, 100 mg samples of C. gracilis cells were incubated with methanol (1 mL, 2.5 mL, and 5 mL) containing 1.2% (v/v) H₂SO₄, at 60° C. for 25 to 150 mm at 25 min intervals (FIG. 1). Samples reacted with 1 mL methanol increased from 4.1 mg of FAME at 25 min to a maximum of 14.8 mg at 125 min. Increasing the volume of methanol used for each 100 mg sample to 2.5 mL increased the yield of FAME to 7.4 mg at 25 min and a maximum yield of 22.6 mg at 150 min. Increasing the volume of methanol further to 5 mL did not result in an increase in the yield of FAME.

It is determined that the volume of methanol necessary for maximal direct conversion of algal lipids to FAME (FIG. 1) is even higher than reported. While high ratios of methanol may be essential for optimal direct conversion of lipids in algae to biodiesel, the direct method disclosed herein optionally eliminates the need for n-hexane extraction prior to transesterification. Additionally, the unreacted methanol may be optionally reused to continue processing algal biomass. The elimination of the n-hexane extraction combined with the potential to reuse excess methanol may significantly reduce the financial impact of the direct transesterification method compared to the traditional two-step process.

### Example 10

### The Effect of Temperature

In certain embodiments, the temperature may be varied, optimized, or set to avoid exceeding the boiling point of the alcohol used to carry out the methods disclosed herein. Prior studies of conventional and in situ methods for converting TAG to FAME demonstrated that increasing the reaction temperature decreases the amount of time necessary to reach a maximal yield of FAME. For example, to increase the efficiency of the reaction without requiring temperatures significantly higher than the boiling point of methanol, experiments were performed to identify the lowest temperature required to reach a maximal yield of FAME in short reaction times of 10 and 20 min. Reactions to study the influence of temperature on FAME yield were carried out with 100 mg samples of C. gracilis and 2 mL of methanol containing 2% (v/v) H₂SO₄ at temperatures ranging from 60 to 110° C. in increments of 10 C.° for either 10 or 20 min (FIG. 2). Reaction times of 10 min yielded 23.7 mg of FAME at a temperature of 60° C. and reached a maximum yield of 33.7 mg FAME at a reaction temperature of 90° C. By increasing the reaction time to 20 min a maximal FAME yield of 34.1 mg are reached with a temperature of 80° C. Significant improvements in FAME yield are achieved when the temperature was increased from 60° C. to 80° C. for 20 min reactions. No additional increase in product yield was observed for temperatures higher than 80° C. The increased rate of reaction with increasing temperature is consistent with other reports of acid catalyzed transesterification reactions conducted either directly on biomass or performed on extracted oil.

### Example 11

### Concentration of the Catalyst

In certain embodiments of the methods disclosed herein, the concentration of the catalyst may be varied, adjusted, or optimized. In addition to time, temperature of reaction, and concentration of reactants, an important variable in the efficient conversion of lipids to FAMEs is the concentration of the catalyst. In situ transesterification reactions, like conventional reactions, utilize either acidic or basic catalysts. For example, sulfuric acid was chosen as the catalyst for these studies because acid-catalyzed reactions have been shown to be effective at converting both TAG and free fatty acids (FFA) into FAME. This is an important consideration as the presence of FFA has been observed as minority constituents of algal lipids. Among in situ transesterification studies that utilized sulfuric acid as the catalyst, the amount used varied. Because of this variation, it was unclear what effect varying the concentration of sulfuric acid in methanol would have on FAME yield using the in situ transesterification method. Samples of C. gracilis cells (100 mg) were incubated with 2 mL of methanol containing varying percentages (1.2%-2.4% v/v) of H₂SO₄ (conc.) for 10 min at 80° C. (Table 3). Samples reacted with methanol containing 1.2% H₂SO₄ yielded 28.2 mg of FAME while the highest concentration of H₂SO₄ in methanol tested (2.4%) yielded 31.7 mg (Table 3). Varying the concentration of the catalyst had a modest effect on the production of biodiesel.

TABLE 3
Effect of catalyst concentration on fatty acid methyl ester yield

| Catalyst Concentration^{a} | FAME |
|---|---|
| (% v/v) | (mg per 100 mg biomass)^{b} |
| 1.2 | 28.2 |
| 1.4 | 30.4 |
| 1.6 | 31.1 |
| 1.8 | 31.8 |
| 2.0 | 32.9 |
| 2.2 | 32.9 |
| 2.4 | 31.7 |

^{a}The amount of H₂SO₄ (conc.) added to methanol, reported as % (v/v).
^{b}Result of a 100 mg sample heated to 80° C. for 10 min with 2 mL of methanol containing varying concentrations of H₂SO₄.

### Example 12

### Maximal FAME Yield

In certain embodiments of the disclosed methods, maximal FAME yield may be optionally achieved. Traditionally the efficiency of the biodiesel production is determined by monitoring the disappearance of TAG, the substrate. For example, as is demonstrated in Table 4, all strains of algae yielded more FAME than expected based on the TAG content. Because of this, knowing whether the reaction is complete presents a challenge. It is possible to have converted all TAG to FAME without approaching the maximal biodiesel yield. To examine whether the conditions reported here result in the maximal production of biodiesel, a sample of the green alga N. oleoabundans (100 mg) containing 3.4% (CDW) TAG, was incubated with 2 mL methanol containing 1.8% (v/v) at 80° C. for times ranging from 5 to 35 min in 5 min increments (FIG. 3). The FAME yield increased from a minimum of 19.4% CDW at 5 min to a maximum of 28.2% CDW at 20 min. Increasing the time of incubation beyond 20 min did not affect the total yield of FAME obtained.

TABLE 4
Application of method to other phototrophic organisms.

| | | | Extractable | | | | Percent |
|---|---|---|---|---|---|---|---|
| | | TAG | lipid content | | FAME | | FAME of |
| | | (mg per 100 | (mg per 100 mg | | (mg per 100 | | extractable |
| Organism | Description | mg biomass)^{a} | biomass)^{b} | | mg biomass)^{e} | | lipid |
| Chaetoceros gracilis | Diatom | 27.3 (±0.67) | 44 | (±0.87) | 36 | (±0.32) | 82 |
| Tetraselmis suecica | Green alga | 6.7 (±0.23) | 23 | (±1.1) | 18^{f} | | 78 |
| Chlorella sorokiniana | Green alga | 7.6 (±0.12) | 23.5 | (±1.36) | 18^{f} | | 77 |
| Synechocystis sp. PCC | Cyanobacterium | ND^{d} | 18.4 | (±0.58) | 7.1 | (±0.19) | 39 |
| 6803 | | | | | | | |
| Synechococcus elongatus | Cyanobacterium | ND^{d} | 17.7^{c} | | 7.1 | (±0.12) | 40 |
| Municipal wastewater | Mixed | <1 | 14.4 | (±0.42) | 10.7 | (±0.32) | 74 |
| lagoon | culture | | | | | | |

^{a}Total TAG content determined by triplicate solvent extractions of 100 mg samples with chloroform:methanol (2:1). Analyses performed in triplicate.
^{b}Total lipid content determined by gravimetric analysis of solvent (chloroform:methanol, 2:1) extractable material from a 200 mg sample. Analysis performed in triplicate.
^{c}Result of the gravimetric analysis of solvent (chloroform:methanol, 2:1) extractable material from a single 200 mg sample.
^{d}Not detected.
^{e}FAME content of cells determined by GC analysis of the chloroform extraction of 100 mg lyophilized algal samples heated to 80° C. for 20 min in the presence of 2 mL of acidified (1.8% conc. H₂SO₄ (v/v)) methanol. Unless otherwise stated samples were performed in triplicate.
^{f}Result of the direct transesterification of a single sample.

### Example 13

### Application of the Method to Other Phototrophic Microorganisms

In certain embodiments, by varying reaction parameters, such as the volume of methanol relative to algal biomass in each reaction, the temperature of reaction, and the catalyst concentration, optimal conditions were determined for the effective conversion of total algal lipids from the marine diatom C. gracilis. Although the reaction parameters determined here proved effective at converting lipids from C. gracilis, which accumulates significant quantities of TAG (27% of cellular dry weight, (CDW)), it remained unclear whether the same reaction conditions would be effective at converting lipids from other phototrophic microorganisms with differing TAG content and diverse cell wall compositions. A group of organisms (Table 1) were selected to determine how effective the optimal reaction conditions were at converting total lipids to FAME regardless of TAG content. The samples used in this study were not necessarily optimized for lipid production but are rather representative samples of the given organism or organisms from a given environment. In addition to the organisms of Table 1, a sample of diverse phototrophic organisms was obtained from a wastewater treatment lagoon to demonstrate the wide applicability of the method to produce biodiesel. The TAG and total extractable lipid content of each organism was determined, TAG content was determined by GC analysis of chloroform:methanol (2:1) extraction of each organism or mixture of organisms. The total extractable lipid content of each sample was established by gravimetric analysis of chloroform:methanol (2:1) extracted lipids. To determine the total FAME content of each sample, the lyophilized biomass (100 mg) was reacted with 2 mL of methanol containing 1.8% (v/v) H₂SO₄ for 20 minutes at 80° C. FAMEs obtained from this reaction were then quantified by GC. The results are reported in Table 4.

The TAG content of each sample varied greatly. The diatom C. gracilis had the highest TAG content (27.3% CDW), while the sample obtained from the municipal wastewater lagoon had the lowest (<1% CDW) (Table 4). The green algae, Chlorella sorokiniana and Tetraselmis suecica, had TAG contents (7.6% CDW and 6.7% CDW, respectively) in between the values obtained for C. gracilis and the wastewater sample. No TAG was detected in the cyanobacteria used in this study. Total extractable lipid content of the algae samples followed a similar trend; C. gracilis had the highest lipid content of 44% CDW, while the municipal wastewater sample contained the least amount (14.4% CDW). Surprisingly, the two cyanobacteria, Synechocystis sp PCC 6803 and S. elongates, had total extractable lipid contents of 18.4% CDW and 17.7% CDW respectively, despite their inability to produce TAG. Often the total extractable lipid content is reported as an indicator of the suitability of a given strain for biodiesel production even though some strains, such as the cyanobacteria used in this study, do not contain TAG, the principal biodiesel feedstock. To accurately identify whether a strain could be used as a biodiesel feedstock, the FAME potential must be determined. To do this, the optimal in situ transesterification reaction parameters determined in this study were applied to each strain, and the results are listed in Table 4. As expected, C. gracilis, the strain with both the highest total lipid and TAG content, also had the highest FAME yield (36% CDW). Unexpectedly the FAME yield exceeded the total TAG present. The FAME yield for each of the other algal strains tested was also higher than the amount of TAG available. The strain T. suecica exhibited the largest difference between the FAME yield (18% CDW) and the amount of extractable TAG (6.7% CDW) available for transesterification. The method of in situ transesterification was also applied to two species of cyanobacteria, Synechocystis sp. PCC 6803 and Synechococcus elongatus. No TAG was expected to be found in these species and none was detected by GC analysis of their total lipid extraction. Despite the lack of TAG, the FAME yield obtained from the in situ transesterification of the two cyanobacteria was 7.1% CDW. Finally the mixed culture obtained from the wastewater lagoon was subjected to in situ transesterification. Though the wild mixed culture contained less than 1% (CDW) TAG, a FAME yield of 10.7% (CDW) was obtained through in situ transesterification.

The data described in Table 4 shows the effectiveness of our method in the direct transesterification at producing biodiesel from a diverse range of organisms. In each case, the direct transesterification method resulted in conversion of all of the triglycerides to biodiesel. Somewhat surprising, however, was the observation that the FAME that could be captured actually exceeded the available triglycerides in each case. For the two green algae, three-fold more biodiesel was obtained compared to that expected from the triglyceride content. This discrepancy is explained by an ineffective extraction technique used to establish the TAG content, leaving a substantial amount of the compound in the cell. The inclusion of acid in direct transesterification reactions facilitates a more efficient extraction by breaking down the cell wall of the organism. In addition, other sources of fatty acids such as membrane lipids can be converted to biodiesel by this method and contributed to the total FAME yield. In further evidence of membrane lipids being converted to biodiesel by direct transesterification, two strains of cyanobacteria, Synechocystis PCC 6803 and Synechococcus elongatus, were selected for direct transesterification. Cyanobacteria are photoautotrophic bacteria and are not known to accumulate TAG. Although TAG was not detected in the total lipid extract for these samples, each cyanobacterium had total extractable lipid contents comparable to the two strains of green algae (˜18% CDW to 23% CDW respectively). Despite the fact that these two cyanobacteria do not contain triglycerides, significant biodiesel could be made, with 7% of the total dry cellular weight and 40% of the total extractable lipid being converted to biodiesel. To confirm the potential for phospholipids to act as substrates for the transesterification reaction, the membrane lipids 1,2-dipalmitoyl-sn-glycero-phosphate and 1,2-dipalmitoyl-sn-glycero-3-phosphoethanolamine (Sigma. Aldrich, St. Louis, Mo.) were reacted using the same conditions as used for direct transesterification, resulting in the production of FAME. The production of FAME from both cyanobacteria and purified membrane lipids demonstrates the biodiesel production from phospholipids using this method. This is consistent with the observation of others that higher yields of FAME were obtained for direct transesterification reactions compared to a two-step extraction followed by conversion approach. Although the strain with the highest biodiesel yield in our studies was the strain with highest TAG, it is significant to note that even samples with low or no triglycerides can be used to make large quantities of biodiesel using the direct method described here. This finding indicates that any source of microbes is a viable feedstock for biodiesel production. To further test this approach, samples were collected from the wastewater lagoon (Logan, Utah). This is a large, open pond system, with a very high proportion of phototrophic microbes at the effluent to the system. Even though the total TAG content of this mixed sample was less than 1%, greater than 10% of the cellular dry weight could be converted to FAME. Although this is three-times less than the amount of biodiesel produced from C. gracilis, the production of the wastewater algae has the benefit of not requiring any input for growth or maintenance.

The parameters for the direct conversion of microalgal lipids presented here are applicable to diatoms, green algae, cyanobacteria, and a wild mixed culture, despite their diverse lipid compositions. The direct transesterification method yielded more biodiesel than was expected from the triglyceride content, indicating capture of fatty acids from membrane phospholipids.

The above description discloses the invention including preferred embodiments thereof. The examples and embodiments disclosed herein are to be construed as merely illustrative and not a limitation of the scope of the present invention in any way. It will be obvious to those having skill in the art that many changes may be made to the details of the above-described embodiments without departing from the underlying principles of the invention.

### Example 14

### Use of Diesel Fuel as a Solvent

In one embodiment, the disclosed method provides for the recovery of biodiesel using pre-existing diesel fuel as a solvent. Optionally, the pre-existing diesel can be either traditional diesel fuels or biodiesel, or both.

In one embodiment, algae may be used as the microbial source for an oleaginous microbial biomass. Alternatively, other microbes may be used. Algae grown as a feedstock for biodiesel production may contain both neutral lipids and phospholipids along with many other molecules both polar and non-polar. In embodiments, the methods disclosed herein are related to processes for converting the neutral and phosphor-lipids of dry or wet algae into fatty acid esters. In embodiments, different alcohols may be used. For example, without limiting the invention, the alcohol may be methanol. The in situ transesterification of algal lipids in the presence of methanol may yield fatty acid methyl esters (FAME) in a crude mixture. Optionally, this one-step process eliminates the traditional two-step process of first organic extraction (using for example hexane) followed by the chemical conversion process using heat, acid or base, and alcohol (such as methanol). Optionally, the methods described herein may eliminate the need for hexane as an extractant.

In embodiments, FAME may be purified from the crude mixture. According to standard practice, this may be done by phase separation following the addition of water and an organic solvent such as hexane or chloroform). The lower organic phase contains the FAME and many other non-polar contaminants. The organic solvent is distilled from this mixture, leaving a crude FAME fraction. The FAME may be purified by distillation under vacuum.

According to embodiments of the present disclosure, diesel fuel may be used as an extracting solvent, eliminating the need for addition of organic solvent and one or both of the distillation steps. The process uses readily available petroleum diesel as a co-solvent and co-fuel. According to some embodiments of the disclosed methods, diesel may be added to a crude mixture containing FAME, where the mixture was optionally produced by the in situ transesterification methods of the present disclosure. The diesel and FAME components separate to the top layer, away from other components of the crude mixture. The top layer may be removed, thus providing a blend of diesel and biodiesel that reflects the proportions of diesel fuel added. The diesel added to the crude mixture may be a traditional diesel fuel, a biofuel, or a combination of both. If the crude mixture containing FAME was produced using algae lipids as described herein, the diesel produced by this embodiment will be a mixture of the diesel added to the crude mixture and algal biodiesel produced by the in situ transesterification. Optionally, this allows for the direct production of a diesel/algae biodiesel blend (such as B10 or B20) without the need for any organic solvent additions or distillation. Optionally, the diesel/biodiesel blend can be further purified by distillation. For example, without limiting the invention, distillation may be by vacuum.

### Example 15

### Effect or Water Content on Fatty Acid Alcohol Ester

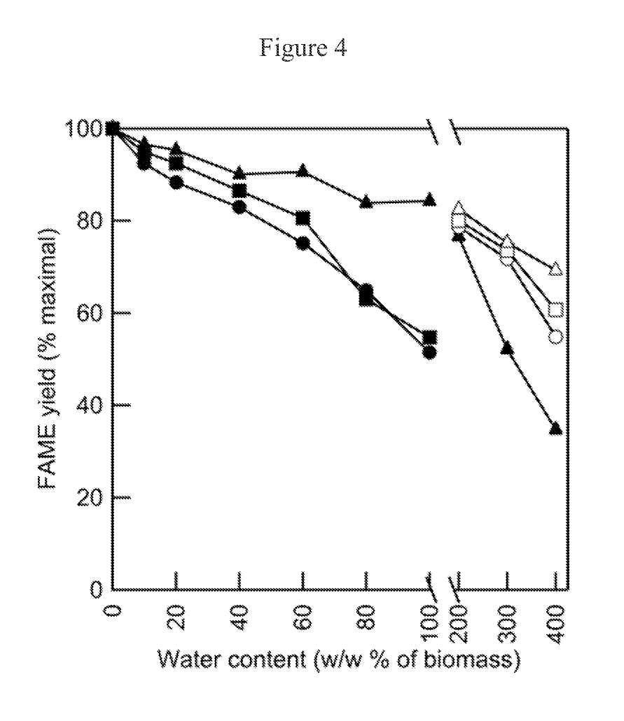

Referring now to FIG. 4, there is shown an example of the effect of water content on fatty acid methyl ester yield from algae. Water content of biomass was varied by adding distilled water to freeze dried C. gracilis cells. Water content is reported as a percentage of the dry algal biomass (w/w %). Wet biomass samples were reacted with varying volumes of methanol containing 1.8% (v/v) H₂SO₄ by heating the mixture to 80° C. for 20 min. The FAME yield observed for samples containing water, reported as a percentage of the dry sample FAME content, is plotted against the water content of the algal biomass in each sample. Volumes of methanol analyzed were , 2 mL; ▪, 3 mL; ▴, 4 mL; ∘, 5 mL; □, 6 mL; and Δ, 7 mL.

Still referring to FIG. 4, the optimal reaction conditions discovered for dry biomass (2 mL methanol, 1.8% (v/v) H2SO4, 80° C. for 20 min) were then applied to the wet biomass and the FAME yield was determined as a function of the water content. Increasing water content progressively decreased the yield of FAME, with equal water and biomass (100% (w/w)) yielding only 50% of the expected FAME. Increasing the volume of methanol to 3 mL per 100 mg of biomass did not significantly improve FAME yields. However, when the volume of methanol was increased to 4 mL a significant improvement in the yield of FAME was observed. FAME yields of 84% of the expected yield were observed in the sample rehydrated with an equal amount of water when 4 mL of methanol were added. This corresponds to 30 mg of FAME from a 100 mg sample, exceeding the biodiesel that could be produced from the TAG (27 mg, Table 4) alone using a conventional approach. Higher water content could be partially compensated by adding more methanol. When methanol volumes of 5, 6, and 7 mL were used with 400% water rehydrated samples, the FAME yields were 54%, 61%, and 69%, respectively, of the expected.

### Example 16

### Alternative Microbes as a Source of Oleaginous Microbial Biomass

The methods related to the present invention may be practiced with any microbial source of oleaginous biomass containing enough lipids for transesterification to occur under the various conditions described herein. Microbial sources of oleaginous microbial biomass include, hut are not limited to algae, yeast, cyanobacteria, bacteria, and combinations thereof.

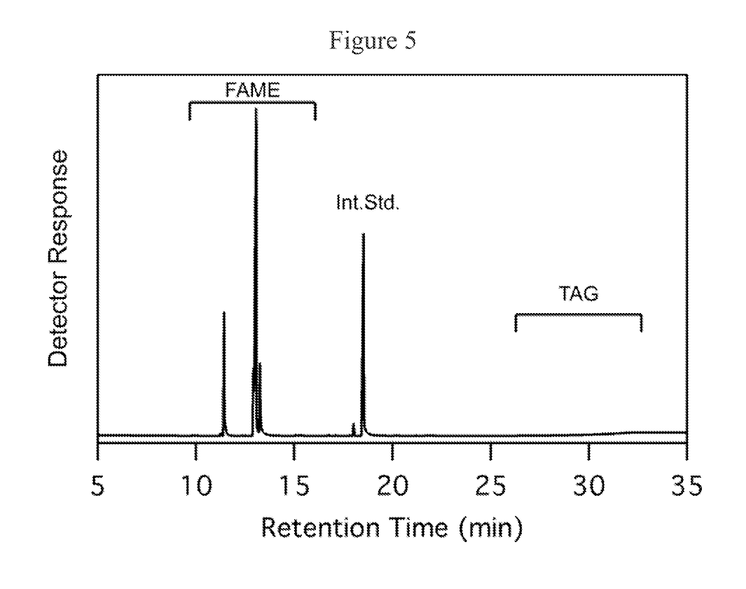

Referring now to FIG. 5, there is shown an example to the conversion of yeast triglycerides into fatty acid methyl esters (labeled FAME). Yeast was treated according to the general methods of the invention as described herein. Following treatment and detection, it was observed that essentially all triglycerides (labeled TAG) were absent, suggesting the triglycerides had been converted into fatty acid alcohol esters. Referring to FIG. 5 in more detail, the alcohol used in the in situ transesterification was methanol, which resulted in the production of a fatty acid alcohol ester. An internal standard (mM. Std.) was used as a control. Optionally, other alcohols described herein may be used. Again referring to FIG. 5, the in situ transesterification of triglycerides is observed by the lack of triglycerides following in situ transesterification. However, it is expected that any or all of the total lipids in the yeast biomass may be converted to fatty acid alcohol esters.

### Example 17

### Monitoring In Situ Transesterification

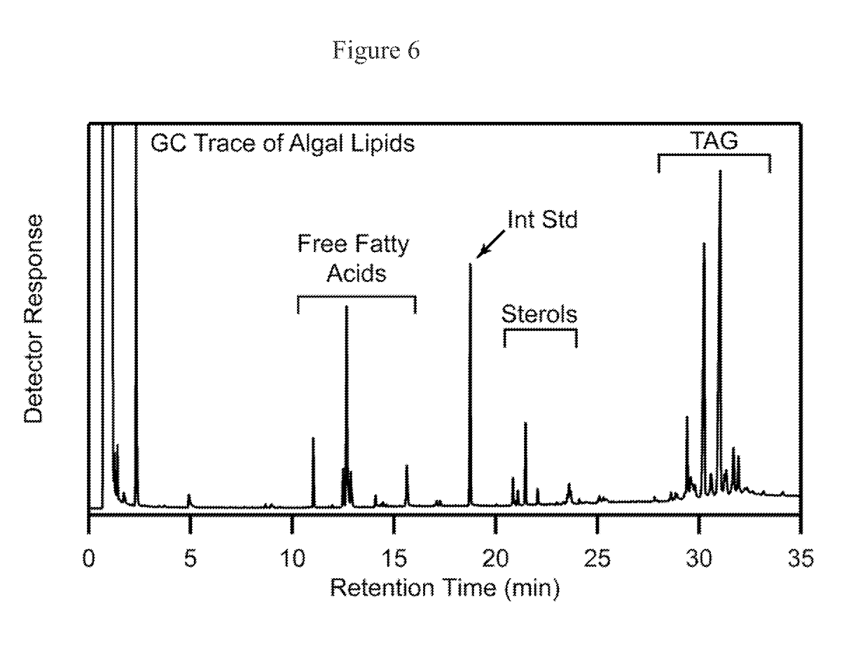

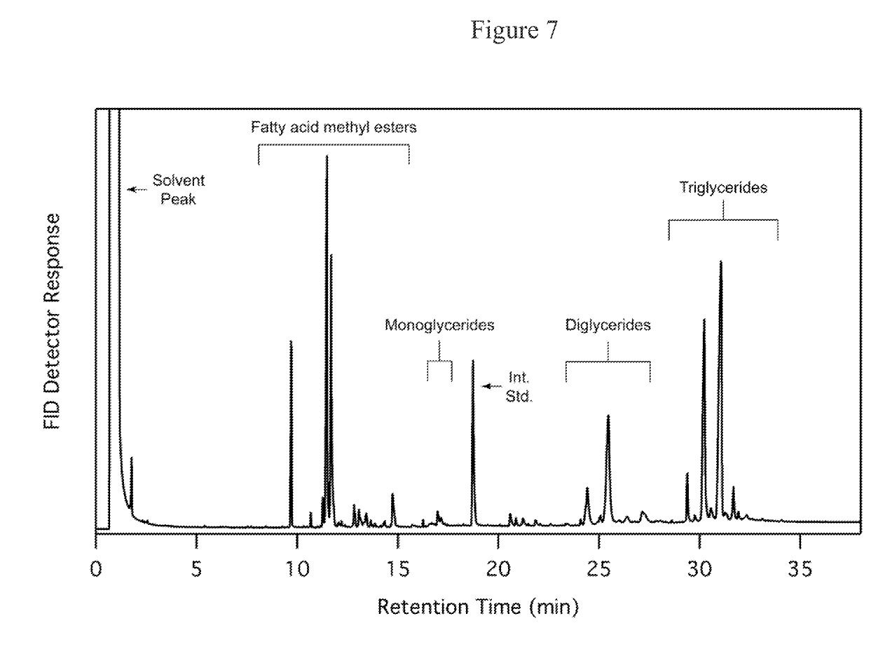

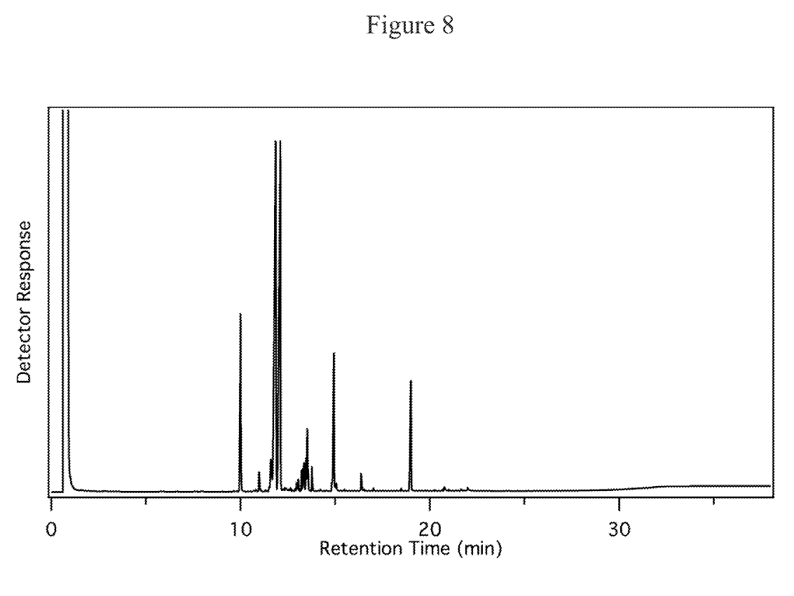

Referring now to FIG. 6 there is a GC trace showing algal lipids prior to conversion by in situ transesterification. Conversion of the algal lipids was carried out according to the methods described herein. The individual lipids may be detected. Referring now to FIG. 7 there is shown a monitoring of the in suit transesterification reaction, in progress. Referring now to FIG. 8, there is shown the GC trace of a completed transesterification reaction. The peaks from 10 min to 15 minutes correspond to fatty acid methyl esters and the peak near 20 minutes corresponds to an internal standard.

We claim:

1. A method of converting microbial lipids from an oleaginous microbial biomass into fatty acid alcohol esters without prior extraction of the lipids from the biomass, comprising, i) contacting an acid catalyst, an alcohol, and an oleaginous microbial biomass containing microbial lipids, under sufficient conditions and for a sufficient period of time for in situ transesterification of at least some microbial lipids to their corresponding fatty acid alcohol ester.

2. The method of claim 1, wherein the acid catalyst is a non-gaseous catalyst.

3. The method of claim 1, wherein the oleaginous microbial biomass comprises total microbial lipids and at least some total microbial lipids are converted into their corresponding fatty acid alcohol esters.

4. The method of claim 1, wherein the microbial lipids comprise at least one lipid selected from a list consisting of triglycerides, five fatty acids, and phospholipids.

5. The method of claim 1, wherein the acid catalyst is H₂SO₄.

6. The method of claim 1, wherein the oleaginous microbial biomass comprises at least one microbe selected from a list consisting of an algae, a cyanobacteria, a yeast, a bacteria, and a mixture thereof.

7. The method of claim 1, wherein the alcohol is at least one alcohol selected from a list consisting of methanol, ethanol, 1-butanol, 2-methyl-1-propanol, and 3-methyl-1-butanol.

8. The method of claim 1, wherein the oleaginous microbial biomass comprises a microbial source from a list consisting of bacteria, yeast, algae, and any combination thereof.

9. The method of claim 1, wherein the contacting an acid catalyst, an alcohol, and an oleaginous microbial biomass containing microbial lipids further comprises adding a volume of acid catalyst to a volume of alcohol to form an acid alcohol solution, then contacting the acid alcohol solution to the oleaginous microbial biomass.

10. The method of claim 8, wherein the volume of acid catalyst added to a volume of alcohol is selected from a list of acid catalyst volumes consisting of between 0.5% and 5.0%, between 1.0% and 3.0%, between 1.2% and 2.4%, and approximately equal to 18% of the total volume of the acid alcohol solution.

11. The method of claim 1, wherein the contacting an acid catalyst, an alcohol, and an oleaginous microbial biomass containing microbial lipids produces a crude mixture comprising fatty acid alcohol esters and alcohol, and, further comprising (i) a step for extracting a fatty acid alcohol ester, pigment and chloroform mixture from a water and alcohol mixture, and (ii) distilling the fatty acid ester, pigment and chloroform mixture to produce a crude fatty acid ester mixture, and (iii) distilling the crude fatty acid ester to produce a substantially pure fatty acid alcohol ester.

12. The method of claim 11, wherein the acid catalyst is a non-gaseous catalyst.

13. The method of claim 11, wherein the oleaginous microbial biomass comprises total microbial lipids and at least some total microbial lipids are converted into their corresponding fatty acid alcohol esters.

14. The method of claim 11, wherein the microbial lipids comprise at least one lipid selected from a list consisting of triglycerides, free fatty acids, and phospholipids.

15. The method of claim 11, wherein the acid catalyst is H2SO4.

16. The method of claim 11, wherein the oleaginous microbial biomass comprises at least one microbe selected from a list consisting of an algae, a cyanobacteria, a bacteria, a yeast, and a mixed culture.

17. The method of claim 11, wherein the alcohol is at least one alcohol selected from a list consisting of methanol, ethanol, 1-butanol, 2-methyl-1-propanol, and 3-methyl-1-butanol.

18. The method of claim 11, wherein the oleaginous microbial biomass comprises a microbial source from a list consisting of bacteria, yeast, algae, and any combination thereof.

19. The method of claim 11, wherein the contacting an acid catalyst, an alcohol, and an oleaginous microbial biomass containing microbial lipids further comprises adding a volume of acid catalyst to a volume of alcohol to form an acid alcohol solution, then contacting the acid alcohol solution to the oleaginous microbial biomass.

20. The method of claim 19, wherein the volume of acid catalyst added to a volume of alcohol is selected from a list of acid catalyst volumes consisting of between 0.5% and 5.0%, or between 1.0% and 3.0%, or between 1.2% and 2.4%, or approximately equal to 1.8% of the total volume of the acid alcohol solution.

21. The method of claim 1, wherein the contacting an acid catalyst, an alcohol, and an oleaginous microbial biomass containing microbial lipids produces a crude mixture of fatty acid alcohol esters and alcohol, and, further comprising (i) a step for extracting the crude mixture comprising fatty acid alcohol esters and alcohol with diesel, wherein the extracting produces a blend of diesel and biodiesel, and, (ii) a step for substantially purifying the blend of diesel and biodiesel.

22. The method of claim 21, wherein the acid catalyst is a non-gaseous catalyst.

23. The method of claim 21, wherein the oleaginous microbial biomass comprises total microbial lipids and at least some total microbial lipids are converted into their corresponding fatty acid alcohol esters.

24. The method of claim 21, wherein the microbial lipids comprise at least one lipid selected from a list consisting of triglycerides, free fatty acids, and phospholipids.

25. The method of claim 21, wherein the acid catalyst is H₂SO₄.

26. The method of claim 21, wherein the oleaginous microbial biomass comprises at least one microbe selected from a list consisting of a microalgae, a cyanobacteria, a yeast, a bacteria, and a mixed culture.

27. The method of claim 21, wherein the alcohol is at least one alcohol selected from a list consisting of methanol, ethanol, 1-butanol, 2-methyl-1-propanol, and 3-methyl-1-butanol.

28. The method of claim 21, wherein the contacting an acid catalyst, an alcohol, and an microbial biomass containing microbial lipids further comprises adding a volume of acid catalyst to a volume of alcohol to form an acid alcohol solution, then contacting the acid alcohol solution to the microbial biomass.

29. The method of claim 28, wherein the volume of acid catalyst added to a volume of alcohol is selected from a list of acid catalyst volumes consisting of between 0.5% and 5.0%, or between 1.0% and 3.0%, or between 1.2% and 2.4%, or approximately equal to 1.8% of the total volume of the acid alcohol solution.

30. A biodiesel fuel or fatty acid alcohol ester component thereof, produced by the method of claim 11.

31. A biodiesel fuel or fatty acid alcohol ester component thereof, produced by the method of claim 21.
